(19) United States
(12) Patent Application Publication
(10) Pub. No.: US 2004/0267812 A1
(43) Pub. Date: Dec. 30, 2004

(54) Media platform

(75) Inventors: Geoffrey Howard Harris, Seattle, WA (US); Patrick John Sweeney, Redmond, WA (US); Kipley John Olson, Mercer Island, WA (US)

Correspondence Address: LEE & HAYES PLLC, 421 W RIVERSIDE AVENUE SUITE 500, SPOKANE, WA, 99201

(73) Assignee: MICROSOFT CORPORATION, REDMOND, WA (US)

(21) Appl. No.: 10/609,295

(22) Filed: Jun. 26, 2003

(51) Int. Cl. G06F 17/30

(52) U.S. Cl. 707/104.1; 707/10

(57) ABSTRACT

A system and method for enabling integration of multiple media providers with a media player is described. This system and method enables multiple media providers to customize a media player to allow access, enable use, and control use of its media through the media player.

### TECHNICAL FIELD

This invention relates to a system and method that enables multiple media providers to integrate their services into a single media platform.

### BACKGROUND

Media content, like songs and movies, can be provided to media users through compact discs (CDs), digital video discs (DVDs), radio, television, satellite, and the Internet, to name a few. Media users have increasingly used the Internet to access media content, in part because of the physical limitations of buying media on CDs and DVDs, and the generally lower quality and range of choice with broadcast sources.

To meet this need for Internet-accessible media content, many media providers have created media access and use applications (hereinafter “provider players”). Some media providers have built provider players that allows users to access their media content online and use their accessed media then or later.

With a typical provider player a user can access media content from the media provider associated with that provider player. Such access includes searching through various media content available from the media provider, for instance.

The typical provider player also allows users to use the media, either while still online or later. This use can include downloading songs, movies, and other media onto computer memory (or a portable device), burning the media onto a CD, or playing the media file.

Media providers desire to retain control on the media downloaded from their service, however. To do so, media from some media providers can only be used on that media provider's player. Because of this, a media provider can control how its media content is used by building these controls into its provider player.

There are various significant problems with provider players, however. These applications are expensive. A media provider building a provider player typically incurs significant expenses in building, testing, and marketing the application.

Another major problem is that users often do not want to learn how to use a new provider player. If a user knows how to use a provider player of media provider “Acme”, for instance, the user is much less likely to learn how to use another, new provider player of a new media provider. Having to learn how to use a new provider player just to gain access to and/or use a new media provider's media content is often too high a bar to cross. Because of this, fewer new customers may be willing to subscribe to a new media provider because they have is to learn how to use its provider player.

### SUMMARY

The following description and figures describe a system and method for integrating multiple media providers with a single media player. This system and method enables a user to use one media player to access multiple media providers, save media files from these multiple media providers, and use the media files. In addition, the system and method allows multiple media providers to control how their media files are used in the media player.

### BRIEF DESCRIPTION OF THE DRAWINGS

FIG. 1 illustrates a screen shot showing an exemplary user interface for a media player presenting multiple media providers to which a user can subscribe.

FIG. 2 illustrates a screen shot showing an exemplary user interface for a media player showing various options and including an exemplary user interface of a media provider.

FIG. 3 illustrates a screen shot showing an exemplary user interface for a media player including an exemplary user interface of a media provider, the provider user interface including a webpage showing media files and a selection to download one of those media files.

FIG. 4 illustrates a screen shot showing an exemplary user interface for a media player presenting a media library of media files.

FIG. 5 illustrates a screen shot showing an exemplary user interface for a media player including a selection to record a media file.

FIG. 6 illustrates a computer system for a media platform, a communication network, and three remote media providers.

FIG. 7 illustrates a media platform and three remote media providers in potential communication with the media platform.

FIG. 8 is a flow diagram of an exemplary method for integrating multiple media providers with a media player and into a media platform.

FIG. 9 illustrates a screen shot showing an exemplary user interface for a media player including a selection to choose to subscribe or be connected to a media provider.

FIG. 10 is a flow diagram of an exemplary method for selection and performance of operations chosen of a remote media provider.

FIG. 11 is a flow diagram of an exemplary method for downloading a media file from a remote media provider.

FIG. 12 illustrates a screen shot showing an exemplary user interface for a media player including an exemplary user interface of a media provider, the provider user interface being integrated into the exemplary user interface for the media player and showing a status of a media file's download.

FIG. 13 is a flow diagram of an exemplary method for performing a requested operation for a media file if the operation is allowed by a media provider to which the media file is attributable.

FIG. 14 is a flow diagram of an exemplary method for allowing or disallowing a use of a media file under certain conditions.

FIG. 15 is a block diagram of a computer system that is capable implementing a media platform.

The same numbers are used throughout the disclosure and figures to reference like components and features.

### DETAILED DESCRIPTION

The following disclosure describes a media platform and related method that enable each of multiple media providers to tailor a media player to allow access, enable use, and control use of its media.

The media platform allows users to use one platform to sign up with, access, and use media content from multiple media providers. By starting with a user interface to which a user is already comfortable, the platform enables users to sign up with multiple media providers with less effort. The media platform also enables media providers to set a user's rights to media received from each media provider. In allowing media providers to set how their media is used, the platform enables media providers to control their media without having to build their own media player.

Media providers benefit from the media platform in many ways. First, media providers save money and time to market by not needing to build their own players. Second, media providers can more easily gain new customers by making it easier for a new user find and subscribe to their service. Each media provider can enable a new user to sign up with their service using a sign-up user interface that they provide but that resides within the user interface of the media platform's media player. This enables each media provider to control the signing-up process to their own specification. Third, once the new user is signed up, the media provider becomes an option within the media player's user interface, thereby making it easy for the new user to connect to the media provider, including to access media content. Media providers benefit in these ways, while being able to maintain control of their media content.

User also benefit from the media platform. Users do not need to learn to use many different media players. Instead, they can access, use, manage, and play media from multiple media sources with just one media platform and just one overarching user interface.

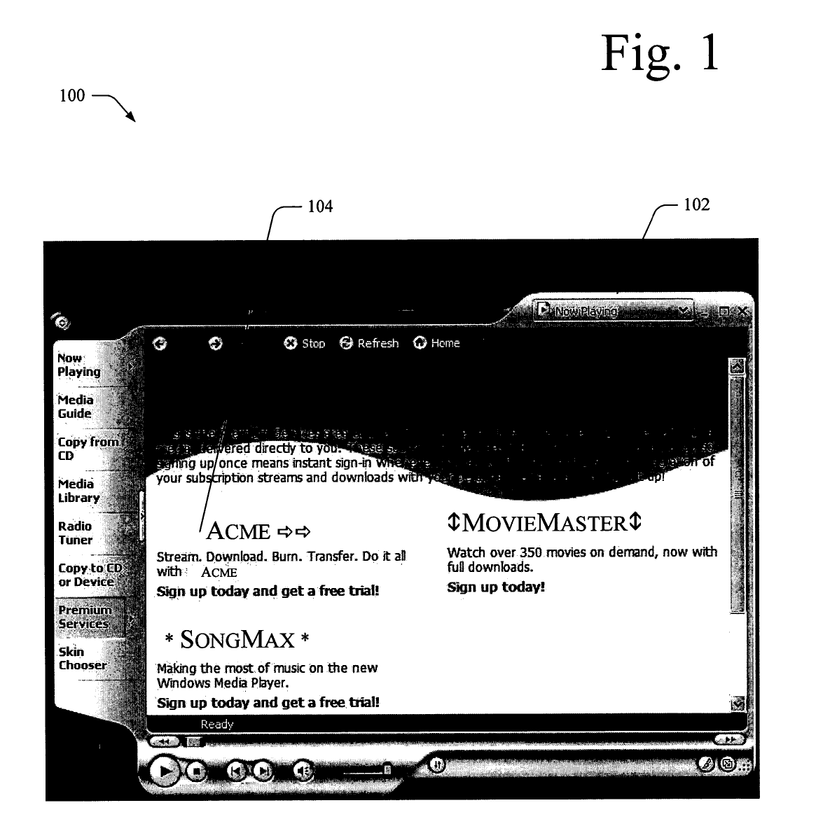

FIG. 1 sets forth a screen shot 100 showing an example of the media player's user interface 102 that is displaying three exemplary, fictitious media providers (Acme, MovieMaster, and SongMax) with which a user may sign up to access and use each media provider's media content.

Once a user has signed up with a media provider, the user can then access that media provider's media content with a user interface integrated within the platform's user interface 102.

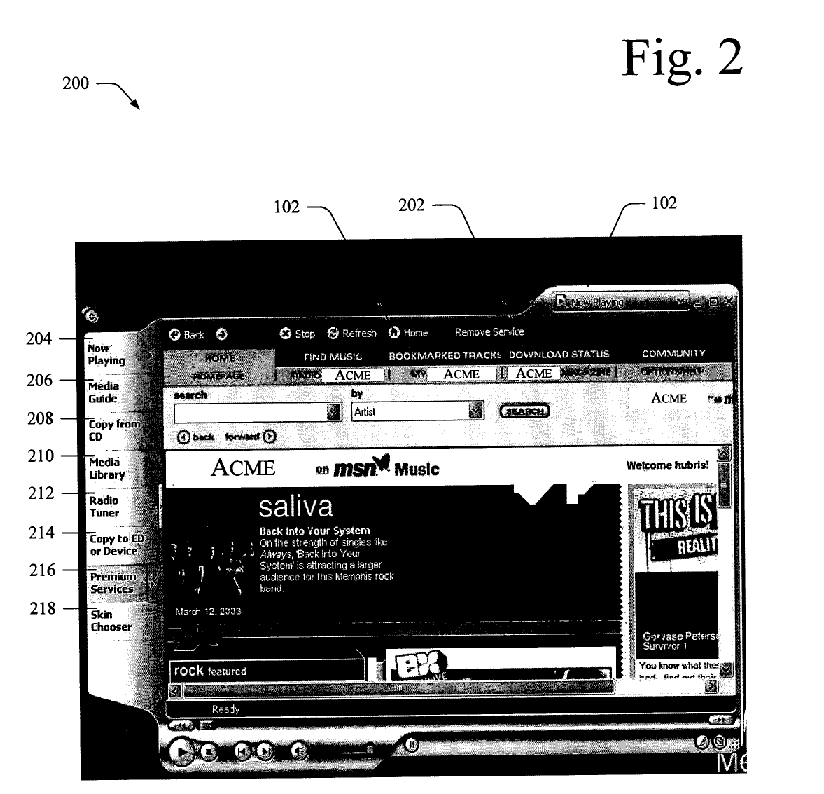

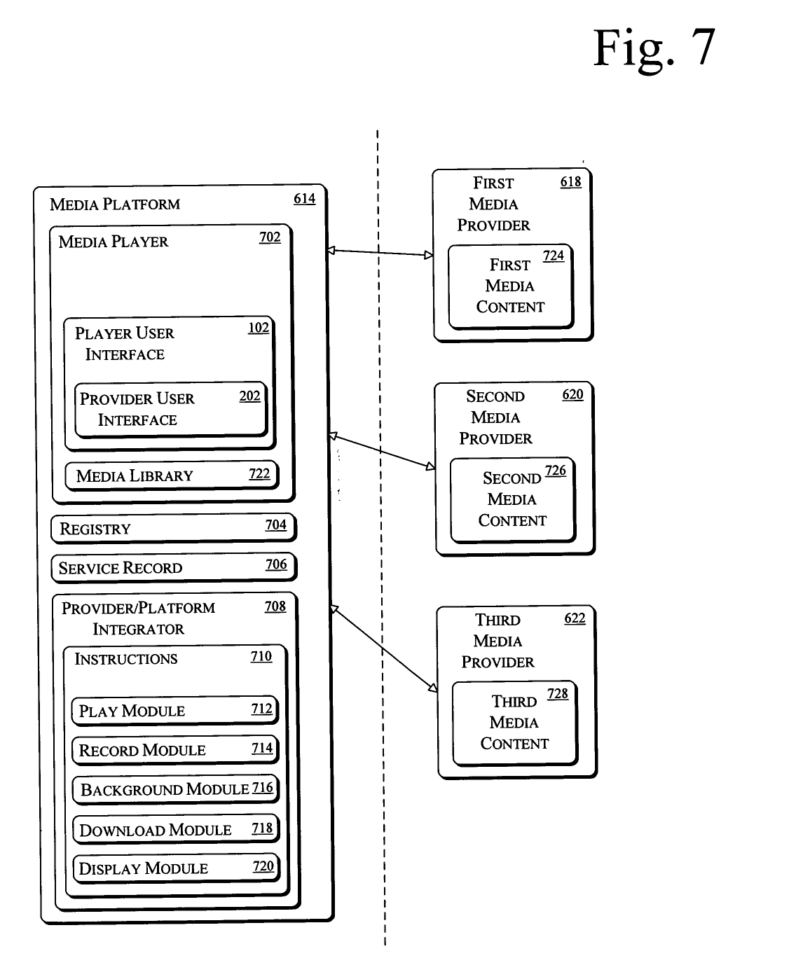

FIG. 2 sets forth a screen shot 200 showing an example of the player user interface 102 and a media provider's user interface 202 integrated into the player user interface 102. (Elements marked with the numerals 204 to 218 will be discussed below, including in the description of FIG. 7).

Through the media provider's user interface 202, the user can perform many different actions, like search through the media provider's offered media content, research metadata about particular media, view the user's account, see special services, and the like.

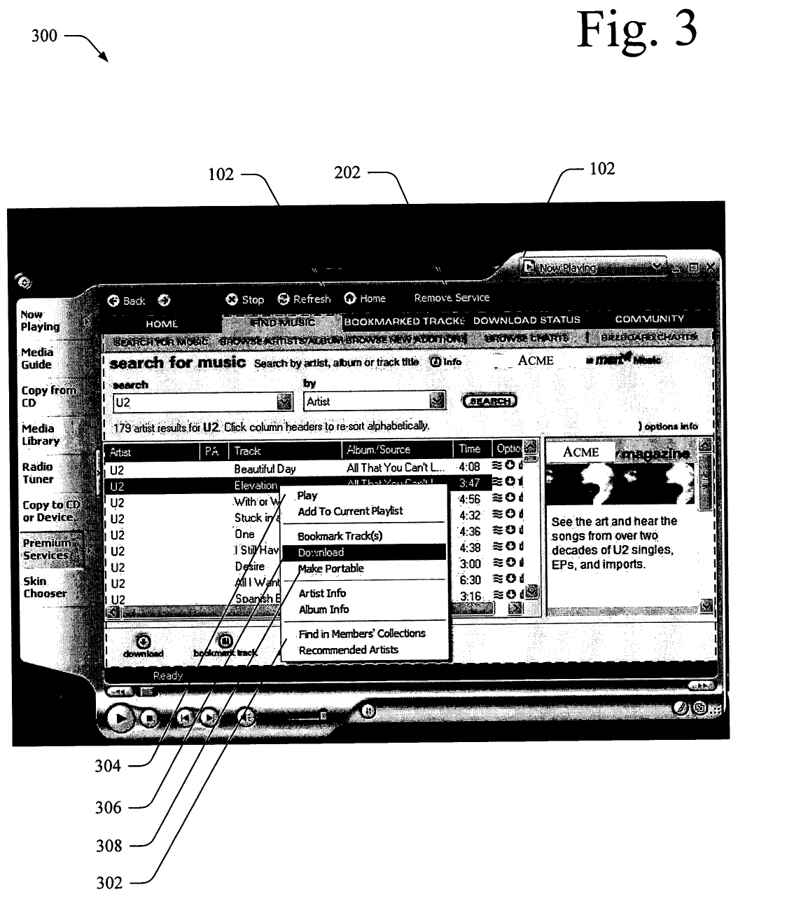

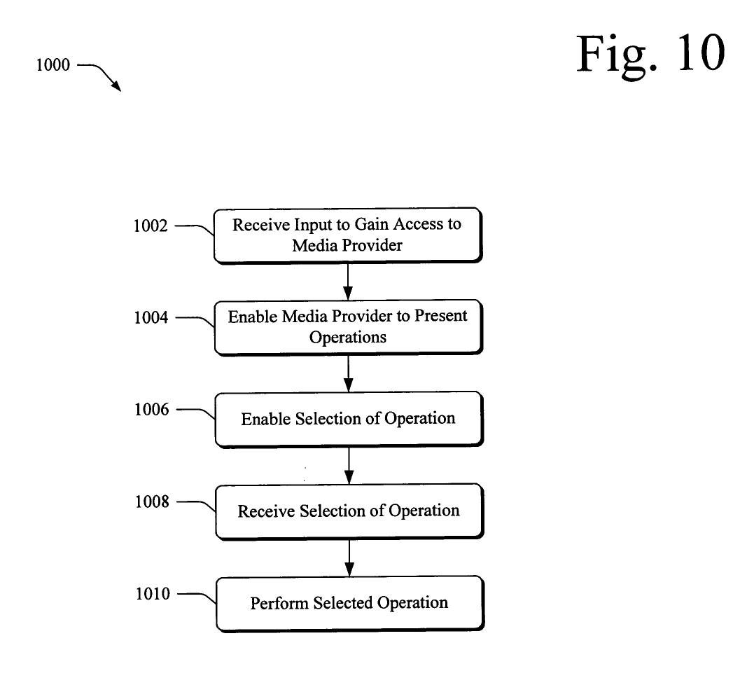

FIG. 3 sets forth a screen shot 300 showing another example of the player user interface 102 and another example of the provider's user interface 202 integrated into the player user interface 102. (Elements marked with the numerals 302 to 308 will be discussed below, including in the description of FIG. 10).

In this example, the provider's user interface 202 shows a search of various media content by the user. The user is searching through songs by the artist “U2”. From a generated list of songs, the user is choosing to download a song entitled “Elevation” from an album entitled, in part, “All That You Can't L.”.

Once the media file is downloaded, metadata regarding the media is stored in the media platform's library. At some future time (or immediately after downloading the media), the user can use the media platform to perform an operation, such as play or burn the downloaded media file (here the U2 song, “Elevation”).

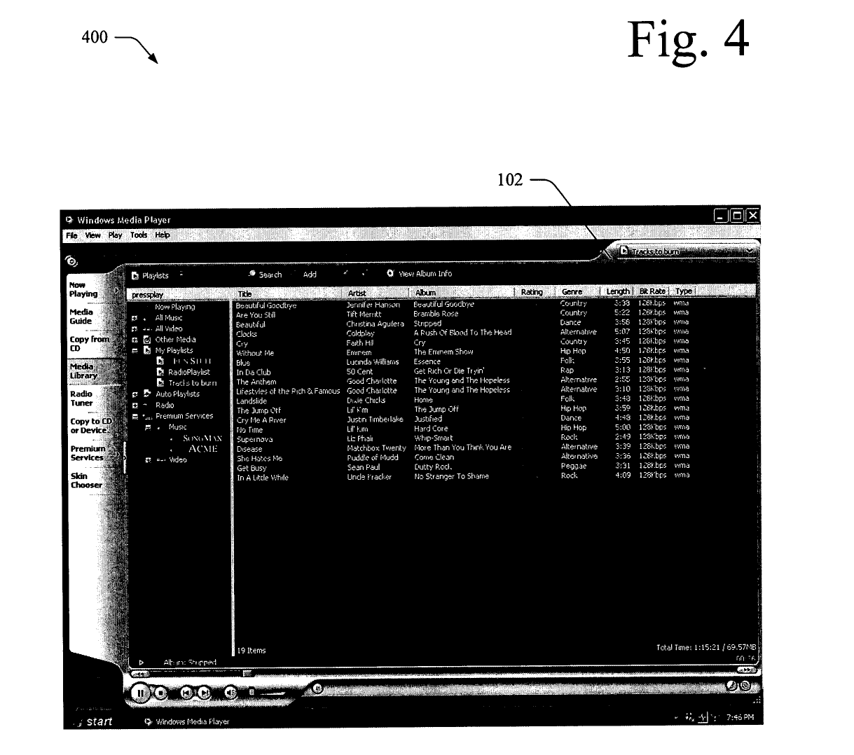

FIG. 4 sets forth a screen shot 400 showing another example of the player user interface 102, the player user interface 102 displaying media files that are included in the media library.

Once the user has selected a media file (such as a media file of a song entitled “Without Me” by the artist “Eminem”), the user can request that the media platform perform an operation with the selected media file. Operations for media files can include playing them, downloading them to a portable device, or burning them, such as onto a CD or DVD.

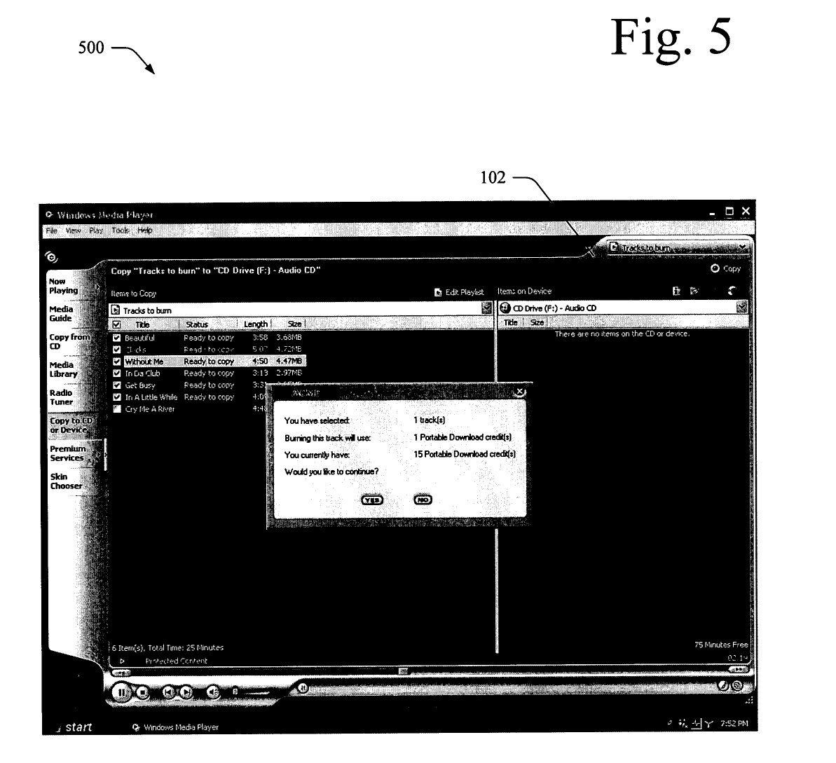

FIG. 5 sets forth a screen shot 500 showing another example of the player user interface 102, the player user interface 102 displaying an attempt by the user to burn the media file onto a CD.

When the user requests that the media platform burn the song onto a CD, various actions are performed by the media platform. These actions will be discussed in greater detail below, and can include checking whether or not the user has the right to burn that media file onto a CD. If the media platform determines that the user has been given a right by the appropriate media provider to burn the song onto a CD, the media platform will perform the burn operation (not shown).

The prior exemplary screen shots and accompanying discussion are intended make the reader familiar with possible uses of the media platform and are not intended to limit the breadth or scope of the media platform and its related methods. The media platform will be discussed in greater detail below. Exemplary methods and systems usable to implement the platform will also be discussed below.

Exemplary System

Overview

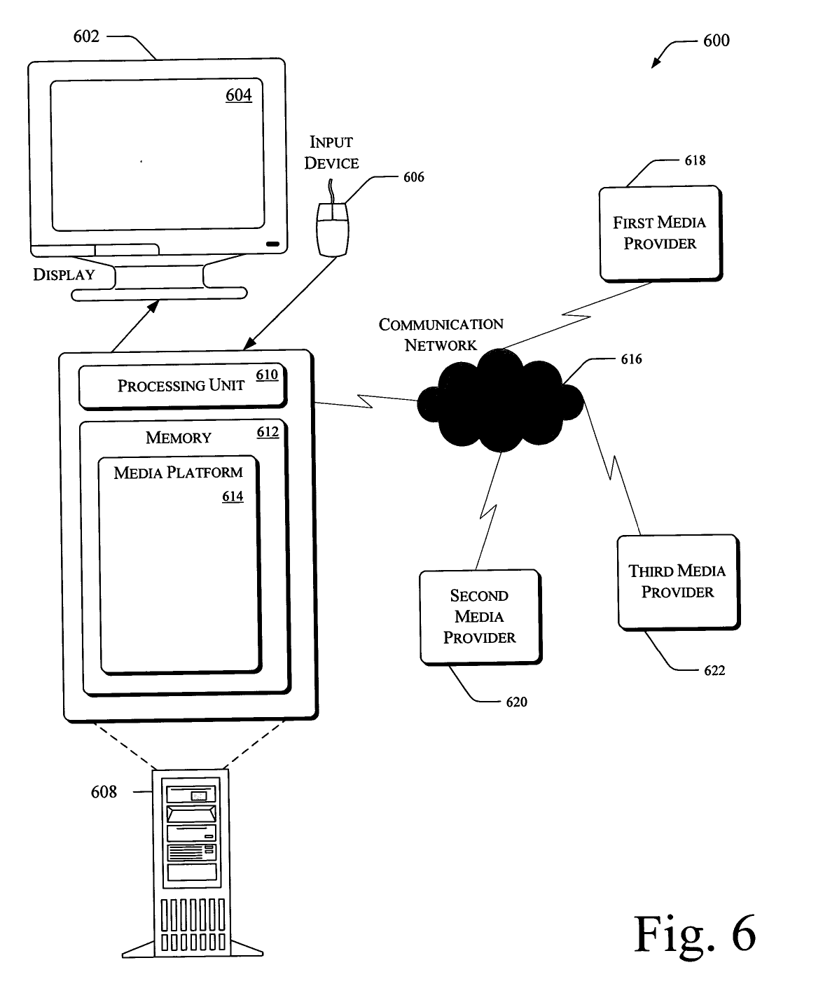

FIG. 6 shows an exemplary system 600 usable to create a media platform and facilitate related methods. The system 600 includes a display 602 having a screen 604, an input device 606, and a computer 608. The input device 606 can include any device allowing a computer to receive input from a user. The user can send input via the input device 606 to the computer 608 to access and control media, for instance. The user can use the display 602 and its screen 604 to view user interfaces and playback of visual media. The user can use speakers and the like to enjoy playback of audio media as well (not shown).

The computer 608 includes a processing unit 610 to execute applications and a memory 612 containing various applications. The memory 612 includes volatile and non-volatile memory, and a media platform 614 described in FIG. 7.

The computer 608 communicates with various media content sources across a communication network 616. The communication network 616 can be a global internet, a local intranet, and the like. The communication network 616 can communicate with the computer 608 in various ways, such as across standard land-line wires, fiber optic wires, or wirelessly.

Through use of the communication network 616, the computer 608 communicates with media content providers, such as a first media provider 618, a second media provider 620, and a third media provider 622. User interfaces and functionality (discussed in greater detail below) from these media providers can be integrated into the media platform 614 to allow a user to access and use media from multiple media providers.

The Media Platform

FIG. 7 shows the media platform 614 included within the memory 612 of FIG. 6, communication between the media platform 614 and the media providers (shown as solid lines), and a boundary between them (shown as a dashed line). The boundary represents the fact that the media providers and the media platform 614 communicate across the communication network 616.

Most relevant components of the media platform 614 include a media player 702, a registry 704, a service record 706, and a provider/platform integrator 708.

The media player 702 is configured to perform various operations associated with a media file. These operations include downloading and playing a media file. Playing a media file can be performed by the media player 702 as part of streaming (data streamed from a remote source) or from permanent or temporary memory. Downloading includes recording a media file onto various permanent or temporary mediums. The permanent mediums can include those in a portable device (like a mini-hard-drive in a portable media player), a CD, a DVD, magnetic tape, a hard-drive in a computer, and other optical, electronic, mechanical, or magnetic devices. The temporary mediums can include random access memory and other temporary memory types, such as those that require some sort of power to maintain the media file.

The media player 702 can also perform various services when playing a media file, like stopping; fast-forwarding; reversing; advancing or reversing to another track on a multi-track media file; changing a volume at which a media file is presented (muting, un-muting, or adjusting the volume); altering a size, location, or look of visual aspects of the media file; and searching and presenting metadata associated with the media file. This metadata can include the name of the media file, the artist, trivia about the media file, where and on what permanent or temporary medium it is stored (if at all), and the like.

The media platform 614 also includes the registry 704. The registry 704 includes a list of media providers from which the media platform 614 can receive and follow instructions. The list of media providers in the registry 704 can be altered, however, as particular media providers become suitable or unsuitable for integration into the media platform 614. Instructions received by a media provider that is in the registry 704 are used by the media platform 614 to customize itself to conform to that particular media provider. These instructions will be discussed in greater detail below.

The media platform 614 also includes the service record 706. This service record 706 includes information stored by the media platform 614 that the media platform 614 may later communicate to a media provider. The service record 706 can include a number of times an operation (like playing or downloading) has been perform by the media player 702 for a particular media file or media files attributable to a media provider. Some media providers wish to keep track of how often their media files have been played or downloaded. Media providers may desire to gain this information to better understand a user's preferences or manage the user's account, such as when the user is charged based on a number of times a media file is played.

The media platform 614 also includes the provider/platform integrator 708 (hereinafter the “integrator 708”). The integrator 708 uses instructions 710 to integrate functional aspects requested or provided by one or more media providers into the media platform 614. If the instructions 710 are not from a media provider on the registry 704, however, the integrator 708 can refuse to receive or follow the instructions 710.

The instructions 710 include or are used by the media platform 614 to build a play module 712, a record module 714, a background module 716, a download module 718, and a display module 720. These modules are called by the media player 702 at various times to aid the media player 702 in determining whether to perform various operations or to integrate information into a player user interface 102 or a provider user interface 202. The media player 702 can call each of these modules at particular instances (discussed below) using APIs (“Application Program Interfaces”).

There can be multiple modules of each type. If a user has subscribed to the first media provider 618, the second media provider 620, and the third media provider 622, for instance, the media platform 614 can include three play modules 712 (one for each media provider). These multiple modules are not shown in FIG. 7. In FIG. 7, each module shown (such as the play module 712) represents a module for each media provider to which a user has subscribed. To which media provider a particular module is attributable is distinguishable by the context in which it is discussed herein.

In one implementation, the media player 702 calls the play module 712, the record module 714, and the download module 718 whenever a user requests that the media player 702 play, record, or download a media file, respectively. As discussed further below, the media player 702 calls the module associated with the media provider to which the media file is attributable.

The play module 712 is a module of computer code that the media player 702 calls to determine whether or not to play a particular media file. Each play module 712 is associated with a particular media provider, such as the first media provider 618. Each play module 712 is associated with a particular media provider so that the media player 702 can determine whether or not media files from that particular media provider should be played or not. Thus, the media platform 614 may include multiple play modules, one for each media provider.

Similarly, the record module 714 is a module of computer code that the media player 702 calls to determine whether or not to record a particular media file, such as to burn a media file onto a CD or DVD. The media platform 614, for reasons similar to those given above for the play module 712, may include multiple record modules, each record module associated with a particular media provider.

The background module 716 is a module of computer code that the media player 702 calls to perform certain actions that do not need to be immediately performed in order to allow a current operation to be approved. These operations are useful to the applicable media provider because they keep track of what the media player 702 has done. It keeps track of the media files associated with the media provider, a number of times each media file has been played, downloaded, and recorded, musical preferences of the user (based on what the user searches and/or play, records, or downloads), and other operations or services performed by the media player 702 or through the media platform 614. As part of keeping track of a user's operations and services, the background module 716 can save and update information in the service record 706. Parts of the service record 706 applicable to a particular media provider can be communicated to that media provider. This communication of services and operations allows each media provider to be deeply integrated into the media platform 614 and its media player 702, which each media provider can use to update accounts and better serve users.

Similarly to the play module 712 and the record module 714, the download module 718 is a module of computer code that the media player 702 calls to determine whether or not to download a media file, such as onto a portable media player. The media platform 614, for reasons similar to those given above for the play module 712 and the record module 714, may include multiple download modules, each download module associated with a particular media provider.

The display module 720 is a module of computer code that the media player 702 or media platform 614 calls to integrate display preferences of a media provider into the media player user interface 102. This display module 720 can include how a web page attributable to the media provider is oriented inside or with the player user interface 102. This display module 720 can also be used to integrate particular graphics, icons, system objects, menus, and other display preferences of a media provider into the player user interface 102.

In this way the media player 702 is configured to be customized based on the instructions 710 and the modules. The instructions 710, the modules, and how they are used will be discussed in greater detail below.

The media player 702 includes the player user interface 102 and a media library 722. Users become accustomed to a particular user interface, in this case the player user interface 102, which usually makes them comfortable using it. By integrating the provider user interface 202 into the player user interface 102, the media platform 614 helps make users more comfortable with the provider user interface 202. The player user interface 102 also orients the user by offering numerous types of services to the user, each with particular user experiences.

In FIG. 2 for example, the player user interface 102 provides the user with options for services and applicable user experiences for each. The player user interface 102 provides options for the user, including: a now playing option 204; a media guide option 206; a copy from CD option 208; a media library option 210; a radio tuner option 212; a copy to CD or device option 214; a premium services option 216; or a skin chooser option 218. By selecting one of these options, the user can experience different user experiences within the player user interface 102, such as visual representations of the player user interface 102 or the provider user interface 202 and different options applicable to a selected option.

As shown in FIG. 2, a user experience from the provider user interface 202 is one experience that the user can enjoy by selecting the premium services option 216. Here the provider user interface 202 integrated within the player user interface 102 shows premium services available from a media provider with that provider's visual representation attempting to advertise a particular type of media content (here songs by the band entitled “Saliva”).

FIG. 3 shows an exemplary user experience for another example of the provider user interface 202 within the player user interface 102, here after the user has also selected to download a media file from the media provider.

Also by way of example, FIG. 4 shows a user experience from the player user interface 102 if the user selects the media library option 210.

In some cases the player user interface 102 acts as a shell around and/or integrated with the provider user interface 202. In FIG. 2, for instance, the player user interface 102 surrounds a visual space provided by a media provider (the provider user interface 202). This internal space within the player user interface 102 can be provider by a provider-generated web page making up the provider user interface 202, such as when a user first signs up with a provider or when the user later visits the provider to search, play, or download media files or otherwise interact with the provider. This internal space can also be provided by the media player 702 in combination with a particular media provider.

These examples of the provider user interface 202 can be used by user to interact with the applicable media provider. This interaction can include many services, like managing an account, choosing media files to download, play, or record, browse media files, and the like. While not shown, multiple providers can supply the provider user interface 202 for integration with the player user interface 102. Each such supplied provider user interface 202 can be tailored specifically to i, the preferences of the supplying media provider.

In other cases, an internal visual space within the player user interface 102 is solely provided by the media player 702 or the media platform 614.

In either case, the player user interface 102 performs various operation and services, whether alone or in conjunction with the provider user interface 202. As stated herein, the media player 702 uses the player user interface 102 to interact with users, play media files within the player user interface 102, and perform other operations and services.

FIG. 1 shows the screen shot 100, which is an example of the player user interface 102 being wholly generated by the media platform 614. In this implementation, an interior space of the player user interface 102 includes a listing of media providers with which a user can sign up. To generate graphical objects associated with each media provider (here icons and special text “Acme”, “SongMax”, and “MovieMaster”) the media platform 614 can call the display module 720 of FIG. 7, through an embedded web control.

Exemplary screen shots showing examples of the player user interface 102 are shown in FIGS. 1-5, 9 and 12 and the provider user interface 202 are shown in FIGS. 2, 3, and 12.

FIG. 7 shows three media providers, the first media provider 618, the second media provider 620, and the third media provider 622. Three media providers are shown as examples of multiple media providers that are integrated or can be integrated with the media platform 614, but fewer or greater numbers of media providers can also be integrated.

The media providers include or allow access by the media platform 614 to media content, such as songs, albums, movies, video clips and the like. The first media provider 618 includes a first media content 724, likewise the second media provider 620 includes a second media content 726, and the third media provider 622 includes a third media content 728. While graphically presented in FIG. 7 as being within the media provider, the media content can be within or without the associated media provider. The graphical representation is meant to represent that the media provider has control or a right to control its associated media content.

Exemplary Methods

Receiving Instructions From Media Providers

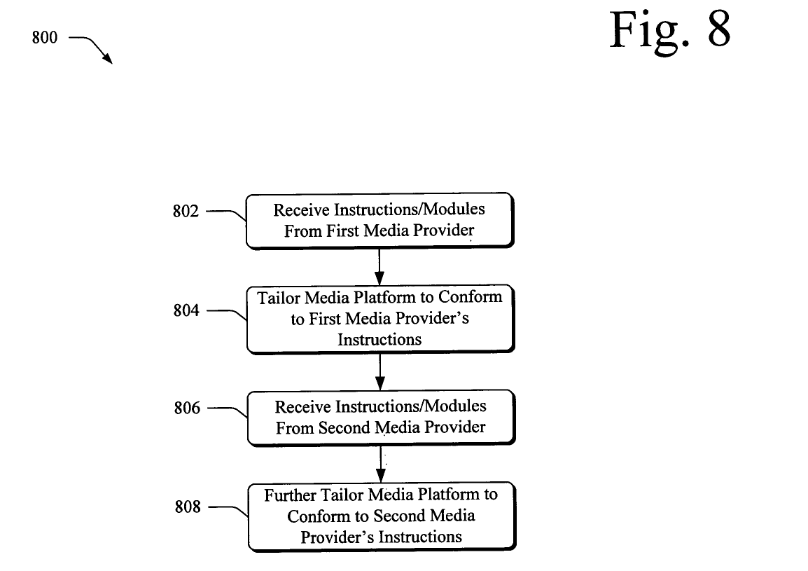

FIG. 8 shows a flow diagram 800 for receiving instructions from multiple media providers that are used to customize the media platform 614. This and the following flow diagrams are illustrated as series of blocks representing operations or acts performed by the system 600. These diagrams may be implemented in any suitable hardware, software, firmware, or combination thereof. In the case of software and firmware, they represent sets of operations implemented as computer-executable instructions stored in memory and executable by one or more processors.

Prior to block 802, the first media provider 618 was registered as an acceptable media provider from which to receive instructions. The media platform 614 either will not receive or if it receives will not implement instructions from media providers that are not listed on the registry 704. This is because the media platform 614 or the user's computer could be damaged by unapproved media providers or those posing as a media provider. In one implementation, however, the media platform 614 can receive and implement instructions from non-listed media providers.

At block 802, the media platform 614 receives instructions from the first media provider 618. These instructions can be received as part of a user's signing up with the first media provider 618, such as by a user selecting to sign up with the first media provider 618 through a first media provider signup icon 104 of FIG. 1 (entitled “Acme”). Selecting the signup icon 104 begins a sign-up process (not shown) after the completion of which the user is signed up with the first media player 618. This process can include a sign-up managed by the media platform 614 within the player user interface 102 or can include rendering web page(s) from the first media provider 618 within the player user interface 102 (such as with the provider user interface 202).

The instructions can be received after being requested by the media platform 614 or sent by the first media provider 618 based on a user signing up with the first media provider 618. Alternatively, the instructions can be received once the first media provider 618 is added to the registry 704 whether or not a user signs up with the first media provider 618.

At block 804, the media platform 614 customizes itself to conform to the instructions. These customizations can take many different forms, from deep functional integration to light or deep user interface integration.

In one implementation, the media platform 614 is configured such that the media platform 614 can customize itself to instructions that are independently created. These instructions can be built wholly without active interaction from the media platform 614, programmers associated with the media platform 614, or the like. Thus, the media platform 614 of this implementation is configured such that it can customize itself to any media provider, known or unknown, that provides instructions that follow certain parameters. In this implementation an independent media provider can create instructions for the media platform 614 to follow without help or interaction from the media platform 614. In this way, the media platform 614 is universally usable and customizable by media providers.

In another implementation, the customizations include storing code modules for later use based on or contained in the instructions from the first media provider 618. These code modules can include the play module 712, the record module 714, the background module 716, the download module 718, and the display module 720, shown in FIG. 7.

Some of the modules can be later used by the media platform 614 to assess whether or not a particular operation can be performed by the media player 702 (like playing or copying to CD a media file from the first media provider 618).

The background module 716 can be used by the media platform 614 to perform tasks in which the first media provider 618 is interested. These tasks can include keeping track of how many times a media file from the first media provider 618 is played, for instance.

The display module 720 can be used to indicate or provide additional user interfaces and functionality when certain conditions occur, such as a pop-up window from or following parameters from the first media provider 618 when a user attempts to burn a media file to CD but does not yet have a right to do so.

In one implementation, the customizations include altering aspects of the player user interface 102. Such aspects can include graphical icons that accompany media files from the first media provider 618. Other aspects can be an audio chime or jingle played when the first media provider 618 or one of its media files is selected by the user, and the like. Still other aspects include rendering web pages from the first media provider 618 within the player user interface 102.

These and other user interface customizations are used by the media platform 614 to alter a user's experience to tailor it to the first media provider's 618 specifications. By tailoring the user's experience, the media platform 614 acts to instill greater brand recognition and loyalty with the first media provider 618. This also allows the first media provider 618 to have an impact on how a user perceives and interacts with the first media provider 618. The first media provider 618 can do so with very little programming or effort. Much of the work behind the user interfaces and experience of users is provided by the media platform 614, rather than needing to be created at the expense and effort of the first media provider 618.

In another implementation, the customizations include adding or altering options and controls available to a user. The media platform 614 can alter options and controls so that a user can request new or improved functions. In one implementation, the media platform 614 adds a selection button for the first media provider 618 after a user has signed up with the first media provider 618.

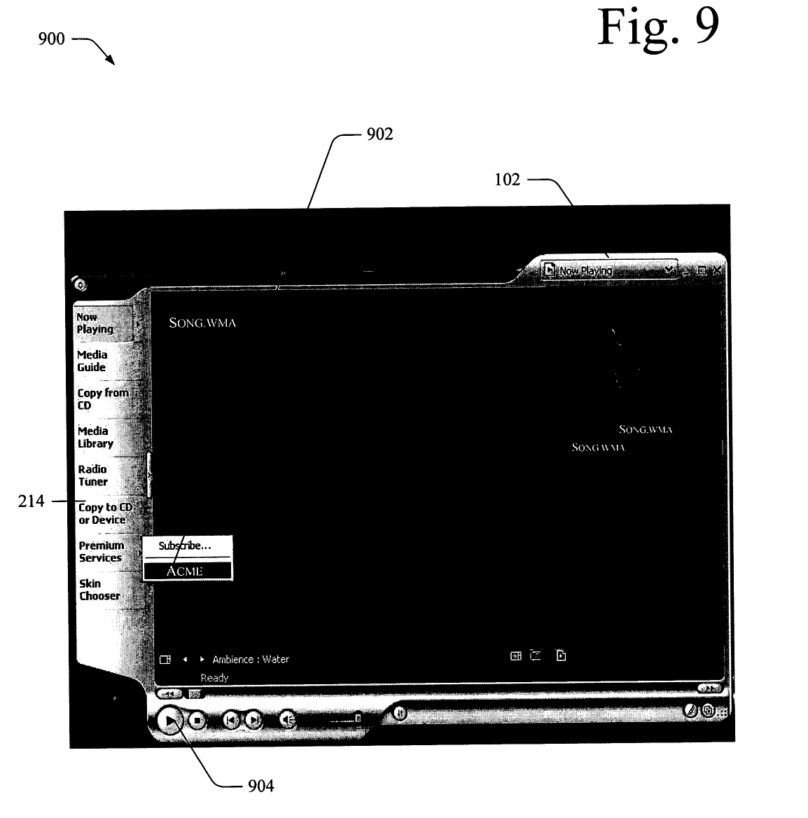

FIG. 9 sets forth an exemplary screen shot 900 showing an example of a first media provider selection button 902. This button 902 has the name or an icon associated with the first media provider 618. It is an added customization to the media platform 614 that allows a user to skip various steps to jump (such as with a URL) directly to a web page of the first media provider 618. This web page can be tailored to the user or generally be tailored to users that have subscribed to the first media provider 618. This is another example of how the media platform 614 uses the instructions 710 from the first media provider 618 to customize itself for the benefit of the first media provider 618.

At block 806, the media platform 614 receives instructions from the second media provider 620. The media platform 614 does so in a manner similar to those set forth for receiving instructions from the first media provider 618. The media platform 614 can continue to receive instructions from multiple other media providers, such as the third media provider 622. In each case, the instructions can be treated separately for each media provider so that the media platform 614 is customized without the media providers conflicting. Thus, while a particular page of the player user interface 102 can include icons for multiple media providers, certain pages of the player user interface 102 can be solely for a particular media provider. If a user selects to browse media files from one media provider or be connected to one media provider, the pages corresponding to these selections will be tailored to the particular media provider.

Similarly, the functional aspects from the instructions 710, such as the modules of FIG. 7, are associated with the appropriate media provider. Thus, if a user later wishes to burn a media file from the first media provider 618, the media platform 614 will use the module associated with the first media provider 618 to assess if the media file can be burned.

At block 808, the media platform 614 tailors itself to conform to the instructions 710 from the second media provider 620. The media platform 614 does so similarly to as set forth above for instructions received from the first media provider 618, though each set of instructions from different media providers can be kept separated and associated with the media provider from which they are received.

Enabling User Interaction with Media Providers

FIG. 10 shows a flow diagram 1000 for enabling a user to access and interact with a remote media provider.

The flow diagram 1000 shows actions performed by the media platform 614 that allow a user to access and view media operations from the remote media provider. These actions performed can also enable performance of an operation selected by the user while connected across the communication network 616 to a remote media provider.

The media platform 614 can perform many different media operations, like play, download (save onto temporary or permanent medium), and make portable (save onto a portable permanent medium) a media file. These operations can be performed when a user is connected to a remote media provider (like the first media provider 618 of FIG. 7), or when not connected (such as when the user is not connected to the communication network 616). The flow diagram 1000 covers operations requested from a media provider by a user when the media platform 614 is connected with the media provider. Operations requested when not connected will be covered in a flow diagram 1300 below.

At block 1002, the media platform 614 receives input to gain access to a particular media provider. A user may wish to gain access to a media provider in order to manage their account with the media provider, search through media files available from the media provider, play, download, or save a media file, gain metadata about media files (like information about the artist), see recommended artists' media files, and the like.

The media platform 614 receives input from a user through a user interface. This user interface can include the player user interface 102, shown in FIG. 9. FIG. 9 shows an exemplary fashion by which the media platform 614 can receive input from the user: the first media provider selection button 902. By selecting this button 902, the user is selecting to be connected to the first media provider 618. Consequently, the media platform 614 receives the input to gain access through the button 902.

At block 1004, the media platform 614 enables the media provider to present selection options for various operations. As shown in FIG. 3, these options can include playing, downloading, and making portable a particular media file. FIG. 3 includes these options in a pop-up window 302. The window 302 includes selection options of play 304, download 306, and make portable 308.

The media platform 614 enables the media provider to present these options by integrating the media provider's user interface 202 into the player user interface 102. Thus, the provider user interface 202 is contained within and integrated with the player user interface 102.

FIG. 3 shows the provider user interface 202 within the player user interface 102. In this example the provider user interface 202 is a webpage of the first media provider 618 fitted within the player user interface 102. As can be seen from FIG. 3, the provider user interface 202 is conformed by the media platform 614 to fit seamlessly within the player user interface 102. This makes integration of user interfaces allows a clear and easy way for a user to use the player user interface 102 to which he or she is accustomed, while also interacting with the provider's user interface 202. The user may not even know that any part of the provider's user interface 202 is a webpage, that it is received across the communication network 616, or that it otherwise is not a seamless part of the player user interface 102.

To clarify what part of the screen shot 300 shown in FIG. 3 is an example of the provider user interface 202, the provider user interface 202 is outlined with a dashed line. A provider's user interface can in integrated in various other ways with the player user interface 102 other than set forth in FIG. 3.

In one implementation (not shown), the player user interface 102 is altered by the media platform 614 to perform all of the graphical user interface aspects, based on the instructions 710 received from the applicable media provider, such that the integration of the media provider does not require graphical input, but rather functional specifications. The instructions 710 can include the display module 720. In this implementation the provider user interface 202 is not a webpage of the media provider.

At block 1006, the media platform 614 enables selection of the presented operations. Continuing the ongoing example set forth in FIG. 3, the media platform 1006 enables a user to select the selection options of play 304, download 306, and make portable 308 from the window 302.

At block 1008, the media platform 614 receives a selection of one of the operations. Thus, in this continuing example a user selected one of the options, such as through graphically selecting it with the input device 606 (e.g., clicking on it with a mouse).

At block 1010, the media platform 614 performs the selected operation. Thus, if the user selected the play option 304 of FIG. 3, the media platform 614 would play the appropriate media file (here the song “Elevation” by “U2”).

If the operation includes downloading a media file, the media platform 614 downloads the media file into the memory 612 or another memory device. As part of downloading the media file, the media platform 614 can perform other useful actions that further integrate media providers into the media platform 614. This further integration makes using the media platform 614 for multiple media providers easier for users.

The media platform 614 can receive metadata about a downloaded media file 614 from the media provider or other sources. This metadata can include information about the media file, such as the artist, the album name, the producer, the company or individual holding rights to the media file, the time of play, what track it is on an album (if applicable), and the like. This metadata can then be provided to the user for later use and as a search tool by which a user can search through media files that have been downloaded.

The media platform 614 can also save the media file into logical, particular locations in the memory 612. The media platform 614 can do so without having to ask the user where he or she would like it saved, but rather can save it in a default location.

Further, the media platform 614 can create folders to hold the media files based on the metadata for the media file. Likewise, the media platform 614 can save the media files under new names based on the metadata. Thus, for the song “Elevation” by “U2” which is part of the album “All That You Can't L . . . ”, the media platform 614 can create a folder entitled “U2”, a subfolder within that folder entitled “All That You Can't L . . . ”, and save the media file under the name “Elevation” within the subfolder.

Also, the media platform 614 can add a link to the media file to the media library 722. This way, the user can later search through his or her library (whether offline or online) and select the media file through the library 722. This library 722 and the media platform's 614 automatic integration of media files downloaded from various media providers makes it easier for a user to find, play, and discover information about his or her media files.

Other operations, like recording a media file onto a portable device, are also performed by the media platform 614. For recording a media file onto a portable device, the media platform 614 downloads the media file onto the portable device's portable memory. The media platform 614 can do so similarly to the download operation above (including saving it under a different name and in newly-created folders).

In those cases where a media provider (here the first media provider 618) retains control of the operations presented to a user, such as when the first media provider 618 is in communication with the user through the communication network 616, the media platform 614 performs the selected operation without determining whether or not the operation is authorized by the first media provider 618. It can do so in these cases because authorization is implied by the first media provider 618 when the first media provider 618 retains control through communication with the media platform 614 at the instant the user requests the operation.

In those cases where a media provider (again the first media provider 618 for our ongoing example) does not retain control of the operations presented to the user, however, the media platform 614 first assesses whether or not performance of the operation is allowed by the first media provider 614. How this assessment is performed shall be discussed in greater detail below.

Downloading Media from a Media Provider

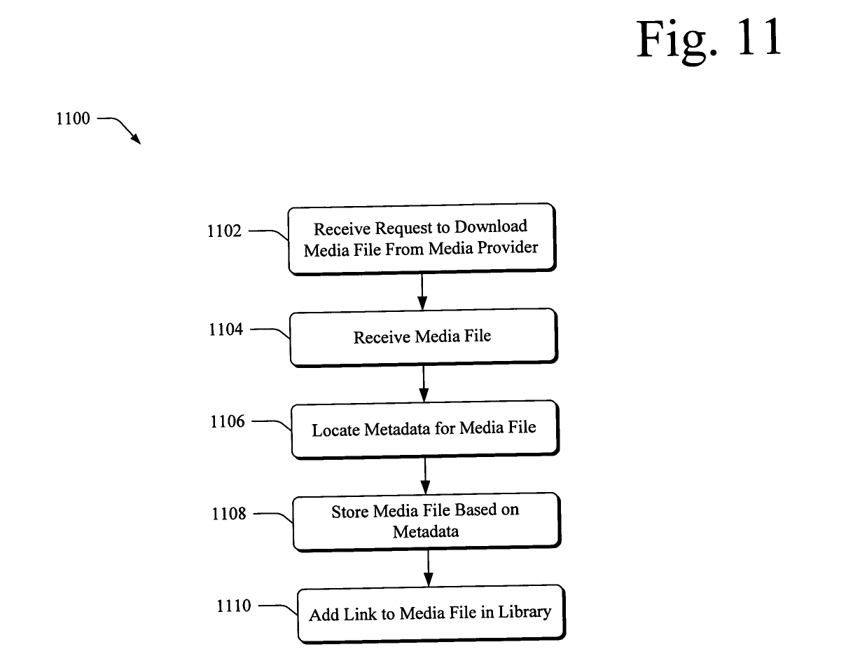

FIG. 11 shows a flow diagram 1100 for downloading a media file from a media provider. This flow diagram 1100 sets forth actions performed to download a file for later use by the user.

At block 1102, the media platform 614 receives a request to download a media file. This request can come from a user directly, or through the media provider. When the request comes from the media provider, it can be due to a request made by the user, or can be due to other causes, like the media provider wishing to provide free or promotional downloads.

At block 1104, the media platform 614 receives the media file. The media file can be received from the media provider directly, or from another source, in which case the media provider provides the media platform 614 with authorization to download the media file.

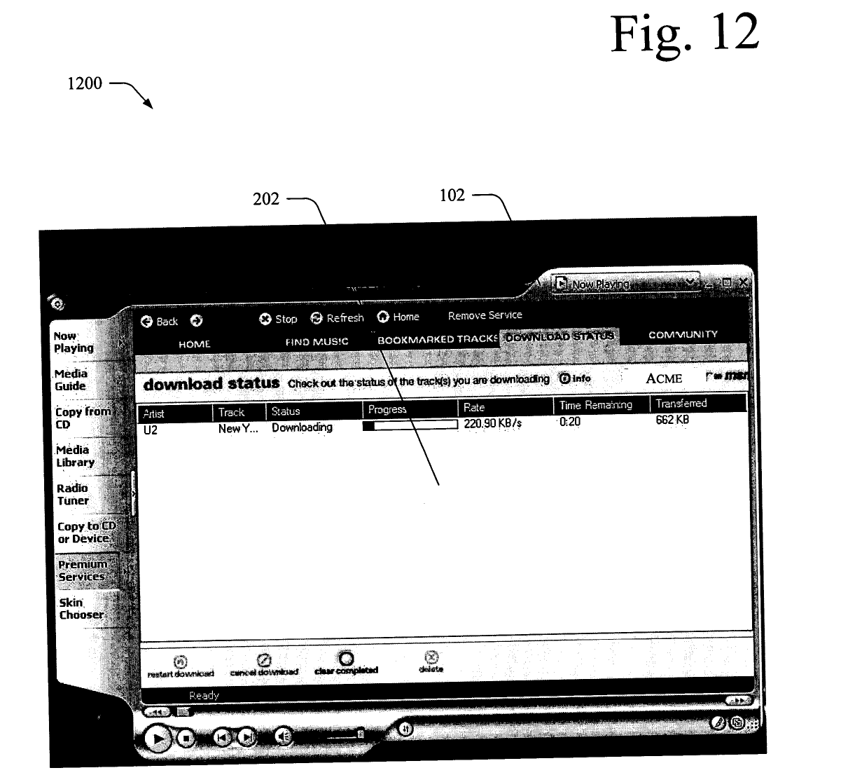

FIG. 12 sets forth a screen shot 1200 showing an example of the provider user interface 202 within the player user interface 102 showing a media file being downloaded. The downloading media file is by the artist “U2” and is a track entitled “New Y . . . ”. In this example the provider user interface 202 is showing the status of the downloading process, but the media player 702 is performing the download. The media player 702 is downloading the media file from a web server controlled by the first media provider 618.

In one implementation, if the receiving of the media file is interrupted (such as by communication with the communication network 616 failing), the media platform 614 saves that part of the media file downloaded. With this part saved, once communication with the communication network 616 resumes, the media platform 614 can automatically resume downloading the media file. The media platform 614 can resume downloading the media file automatically or can inquire from the user whether or not the user wishes to resume the download now, later, or give up.

At block 1106, the media platform 614 locates metadata for the downloaded or to-be downloaded media file. This metadata includes various information about the media file or the media provider associated with the media file. This information can include the media file's current name, artist, track, album, run time, advisory statement (such as a parental advisory for explicit lyrics or a restricted movie rating), interesting facts about the media file or artist, copyright information, producer, director, country of origin, and other information desired about the media file.

At block 1108, the media platform 614 stores the media file based on some of the metadata located. This storing can be performed by the media platform 614 immediately after the media file is received, and without user interaction. By so doing the user can download media files with little effort. As set forth above, the media file can be stored in a folder with a name of the artist or album, which the media platform 614 can create if it does not exist. The, media platform 614 can also change the name for the media file to be more intuitive to the user, such as by changing its name to be the media file's common title. If, for instance, a media file has a name “JefAp_{—}2_{—}06_{—}128k_Lather_.wma”, the media platform 614 can save under a new name, like “Elevation” (the title of a song selected in FIG. 3).

As part of this step, the media platform 614 also can store all or some of the metadata into a separate location for later use, such as in the media library 722.

At block 1110, the media platform 614 adds a link to the downloaded media file to the media library 722. The media platform 614 can add this link to the media library 722 without interaction from the user. By adding this link automatically, the user can, without any effort, find the media file easily by searching through the media library 722. This media library 722 can include all the media files accessible by the media player 702, such as media files illegally downloaded, media files legitimately downloaded, including from the first media provider 618, the second media provider 620, and the third media provider 622, for instance. By including links (and potentially, extensive metadata) about many media files, even if they come from many different sources, a user can search through and use his or her media files with little effort.

By automatically integrating new media files into the media library 722, the media platform 614 makes using the media player 702 easier and simpler for users, even if the media files come from multiple media providers.

Using a Media File from a Media Provider

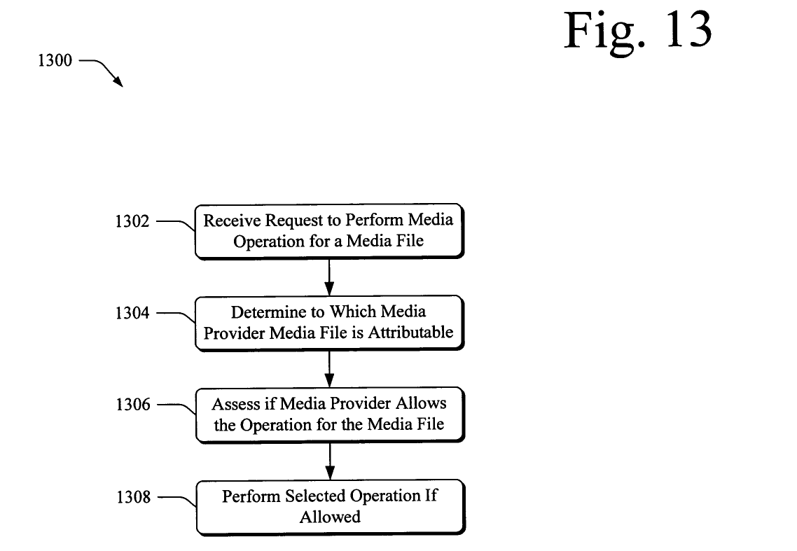

FIG. 13 shows a flow diagram 1300 for using a media file associated with a media provider. This flow diagram 1300 covers instances in which a user requests an operation for a media file that is already accessible by the media platform 614. The media file can be accessible by having been downloaded onto the computer 608 (shown in FIG. 6), a connected memory device (not shown in FIG. 6), or otherwise, so long as it is accessible by the media platform 614 (or parts thereof, like its media player 702). Before performing a requested operation, the media platform 614 determines whether or not the applicable media provider authorizes the requested operation on its media file. By so doing, the media platform 614 integrates functionality for a media provider. This integration enables the media provider to control how its media files are used.

At block 1302 the media platform 614 receives a request to perform a media operation for a media file. The request can be received by the user selecting from options in a drop-down list, through key-entered commands, indirectly or in other manners, or through graphically selecting an operation presented by the player user interface 102.

FIG. 9 sets forth the screen shot 900 showing an example of the player user interface 102. In this example, the player user interface 102 is ready to perform an operation for the media file “Song.wma”. As shown in this example of the player user interface 102, a user can graphically select to play the media file by selecting a play button 904 or the copy to a CD or device option 214. The copy option 214 is described in greater detail herein, but includes copying the media file to a permanent medium (like a CD, DVD, or other memory device), or copying/downloading to a portable device.

At block 1304, the media platform 614 determines to which media provider the selected media file is attributable. In some cases a media file will not be attributable to a media provider, such as when the media file was privately created, is in the public domain, or was gained illicitly. In these cases the media player 702 can play and otherwise perform operations on the media file without the actions in blocks 1304, 1306, or 1308 needing to be performed.

The media platform 614 can determine to which media provider the media file is attributable (if any) with aid of a unique identifier for the media provider. This unique identifier can be found within the media file, including in a header added to the media file when the media platform 614 first downloaded the media file. These ways of determining can be performed whether the media platform 614 is in communication with the communication network 616 or otherwise.

The media platform 614 can also determine to which media provider the media file is attributable by searching through a database that correlates media files to media providers. This database can be within the memory 612 of computer 608 or accessible via the communications network 616.

Once the media platform 614 determines to which media provider the media file is attributable, the media platform 614 assesses whether or not the media provider allows the requested operation for that media file (block 1306). This ability of the media platform 614 to make this assessment allows deep integration of functions desired by many media providers.

The media platform 614 can assess whether or the requested operation is allowed based on the instructions 710 received from the media provider. These instructions 710 can be in the form of or allow creation of computer code modules (like those set forth in FIG. 7). Each module can be executed for a particular requested operation to determine if the operation is allowed. To execute a code module the media platform 614 can call it with an API associated with that particular code module.

For example, if the operation requested is to copy a media file onto a CD, the media platform 614 can execute the record module 714 of FIG. 7. The record module 714, when executed, determines whether or not the user has a right to record (copy) the media file, which it communicates to the media platform 614.

When a code module is stored in the memory 612 of the computer 608, the media platform 614 assesses whether or not the operation is allowed by the media provider without having to communicate with the media provider (such as the first media provider 618 of FIG. 6). This offline/off-communication assessment allows the first media provider 618 to control how its media files are used by a user without the first media provider 618 needing to be in communication with the media platform 614.

At block 1308, if the operation is allowed, the media platform 614 will perform it. If not, it will not.

In one implementation, however, if the media platform 614 assesses that the request record operation is not allowed (by executing the record module 714), the record module 714 and the media platform 614 can work together to facilitate recording the media file. In this implementation, the record module 714 generates a dialog box or other interface to communicate with the user. Here the user is told that the operation is not allowed, but that if the user wishes to purchase a right to record the media file that it will be allowed. This dialog box (not shown) presents options to the user, such as to purchase the right to record the media file from existing credits, to purchase the right but pay for it later, and not to purchase or record the media file at this time. This purchasing of the right can be completed with the media platform 614 and the record module 714 without contemporaneous communication with the applicable media provider or otherwise.

If the right is purchased without contemporaneous communication with the applicable media provider the media platform 614 can create a record that the user agreed to purchase the right so that at some future time the media platform 614 will communicate that the right was purchased and what operation was performed. This record can be retained in the service record 706 of FIG. 7.

If the right is purchased while in communication with the applicable media provider, the media provider is in direct communication with the user, such as through the provider user interface 202 within the player user interface 102. Here the user and the media provider can interact according to how the media provider wishes to build its provider user interface 202. In this case the media platform 614 may or may not record the operation in the service record 706.

Using a Media File from a Media Provider

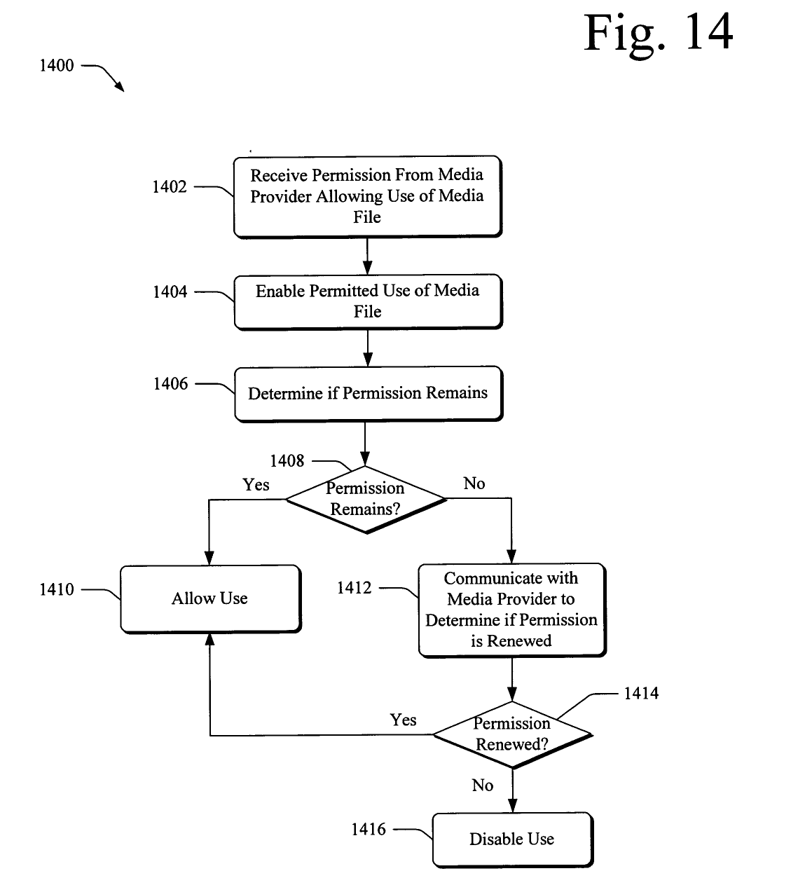

FIG. 14 shows a flow diagram 1400 covering allowance and expiration of a right to use a media file associated with a media provider. This flow diagram 1400 covers instances in which a user's right to a currently stored media file can cease based on an occurrence of a particular event. This is another example of how functionality desired by a media provider can be followed by and integrated into the media platform 614.

At block 1402 the media platform 614 receives permission for a particular operation to be performed for one or more media files. This permission can be received when the user first signs up with the media provider, such as in the instructions 710 received from the media provider at that time. This permission can also be received when the user communicates with the media provider through the media platform 614, such as when the user interacts with the media provider though the provider user interface 202. Also, this permission can be part of the media file, such that when the media file is downloaded it contains an indication that certain operations are allowed based on certain conditions.

For example, if a user signs up with the second media provider 620, the instructions 710 from the second media provider 620 can indicate that the user has a right to download as many songs as he or she likes, but that he or she can only play those songs for so long as the user maintains a monthly license with the second media provider 620. In this example, the operation permitted is playing one or media files, but that permission can expire based on an event (a certain amount of time elapsing without the permission being extended). For this example assume that the right to play the media files expires 30 days after the user signed up with the second media provider 620.

At block 1404 the media platform 614 enables the permitted operation of the media file. In the ongoing example, the media platform 614 will play any media file from the second media provider 620 (so long as the permission remains).

At block 1406, as an ongoing matter, or after request by the user to perform an operation, the media platform 614 determines if the permission remains. In one implementation, the media platform 614 determines if the event has occurred that triggers the permission to be deactivated. In the ongoing example, if it has been 30 days since the user signed up with the second media provider 620, the user will no longer have permission to play the media files attributable to the second media provider 620.

In another implementation, the media platform 614 checks against a record to determine if the permission remains. This record can be the service record 706 of FIG. 7. The service record 706 can be used to retain a number of times a media file is played, downloaded to a portable device, and recorded. It can also retain a number of times the user plays, downloads, and records media files attributable to a particular media provider. In this implementation, the media provider associated with a particular media file can base continued permission to perform an operation on a number of times a particular event occurs. If, for instance, a user wishes to play a media file a 36^{th} time, and the applicable media provider only allows the media file to be played 35 times, when the media platform 614 checks the service record 706 and finds that the media file has already been played 35 times, the permission will expire.

Similarly, if the user is attempting to record a particular media file, the media platform 614 can determine if the user has a right to record the media file based on whether or not the service record 706 shows that the user has recorded that media file a maximum number of times or has recorded other media files an aggregate maximum number of times.

At block 1408 if the permission remains the media platform 614 proceeds along the “Yes” path to block 1410. If not, it proceeds along the “No” path to block 1412.

At block 1410, the media platform 614 allows the use. Continuing the ongoing example, the media platform 614 will play media files from the second media provider 620 for the first 29 days after the user signed up with the second media provider 620.

At the block 1412, the media platform 614 communicates with the media provider to which the permission was earlier granted but not longer remains. Here the media platform 614 determines whether the media provider has renewed the permission. In the ongoing example, at day 35 after the user signed up with the second media provider 620, the right to play media files ceased. By communicating with the second media provider 620, the media platform 614 determines if the permission is renewed (such as by the user paying a second month's subscription fee) or not.

At block 1414, if the permission is renewed, the media platform 614 proceeds along the “Yes” path to block 1410 and allows the use. If not, it proceeds along the “No” path to block 1416.

At block 1416 the media platform 614 disables the no-longer-permitted use. Thus, in the ongoing example, the user will not longer be permitted to play media files from the second media provider 620.

A Computer System

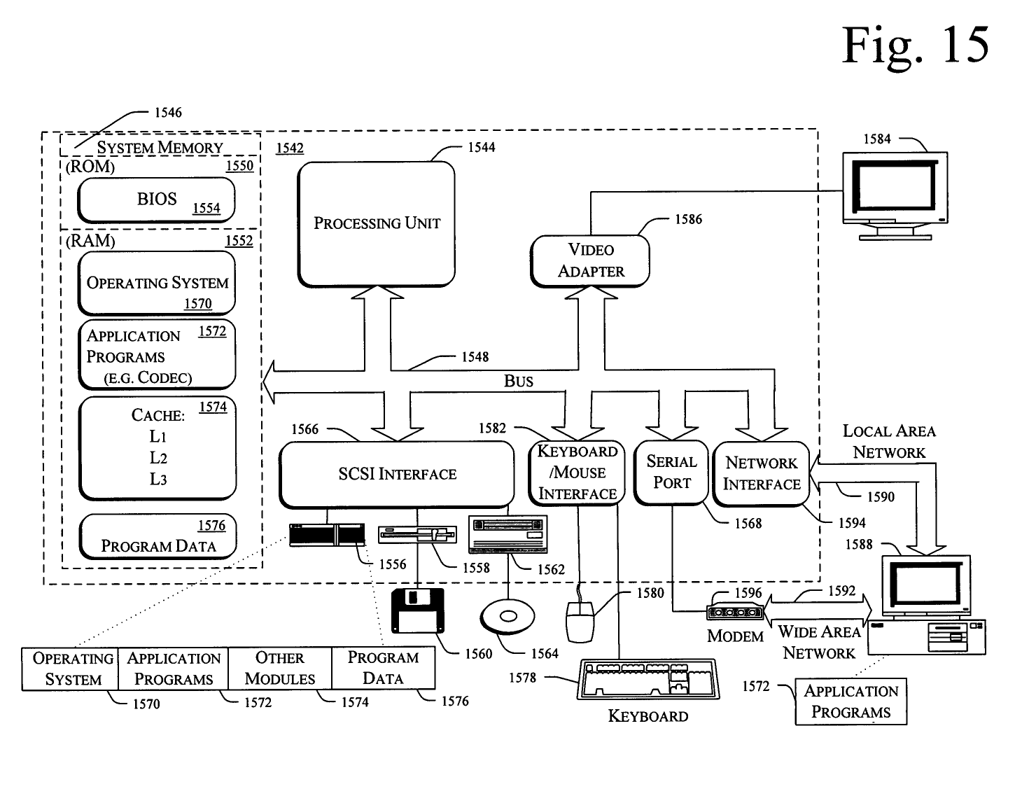

FIG. 15 shows an exemplary computer system that can be used to implement the processes described herein. Computer 1542 includes one or more processors or processing units 1544, a system memory 1546, and a bus 1548 that couples various system components including the system memory 1546 to processors 1544. The bus 1548 represents one or more of any of several types of bus structures, including a memory bus or memory controller, a peripheral bus, an accelerated graphics port, and a processor or local bus using any of a variety of bus systems. The system memory 1546 includes read only memory (ROM) 1550 and random access memory (RAM) 1552. A basic input/output system (BIOS) 1554, containing the basic routines that help to transfer information between elements within computer 1542, such as during start-up, is stored in ROM 11550.

Computer 1542 further includes a hard disk drive 1556 for reading from and writing to a hard disk (not shown), a magnetic disk drive 1558 for reading from and writing to a removable magnetic disk 1560, and an optical disk drive 1562 for reading from or writing to a removable optical disk 1564 such as a CD ROM or other optical media. The hard disk drive 1556, magnetic disk drive 1558, and optical disk drive 1562 are connected to the bus 1548 by an SCSI interface 1566 or some other appropriate interface. The drives and their associated computer-readable media provide nonvolatile storage of computer-readable instructions, data structures, program modules and other data for computer 1542. Although the exemplary environment described herein employs a hard disk, a removable magnetic disk 1560 and a removable optical disk 1564, it should be appreciated by those skilled in the art that other types of computer-readable media which can store data that is accessible by a computer, such as magnetic cassettes, flash memory cards, digital video disks, random access memories (RAMs), read only memories (ROMs), and the like, may also be used in the exemplary operating environment.

A number of program modules may be stored on the hard disk 1556, magnetic disk 1560, optical disk 1564, ROM 1550, or RAM 1552, including an operating system 1570, one or more application programs 1572 (such as the media platform 614), other program modules 1574, and program data 1576. A user may enter commands and information into computer 1542 through input devices such as a keyboard 1578 and a pointing device 1580. Other input devices (not shown) may include a microphone, joystick, game pad, satellite dish, scanner, or the like. These and other input devices are connected to the processing unit 1544 through an interface 1582 that is coupled to the bus 1548. A monitor 1584 or other type of display device is also connected to the bus 1548 via an interface, such as a video adapter 1586. In addition to the monitor, personal computers typically include other peripheral output devices (not shown) such as speakers and printers.

Computer 1542 commonly operates in a networked environment using logical connections to one or more remote computers, such as a remote computer 1588. The remote computer 1588 may be another personal computer, a server, a router, a network PC, a peer device or other common network node, and typically includes many or all of the elements described above relative to computer 1542. The logical connections depicted in FIG. 15 include a local area network (LAN) 1590 and a wide area network (WAN) 1592. Such networking environments are commonplace in offices, enterprise-wide computer networks, intranets, and the Internet.

When used in a LAN networking environment, computer 1542 is connected to the local network through a network interface or adapter 1594. When used in a WAN networking environment, computer 1542 typically includes a modem 1596 or other means for establishing communications over the wide area network 1592, such as the Internet. The modem 1596, which may be internal or external, is connected to the bus 1548 via a serial port interface 1568. In a networked environment, program modules depicted relative to the personal computer 1542, or portions thereof, may be stored in the remote memory storage device. It will be appreciated that the network connections shown are exemplary and other means of establishing a communications link between the computers may be used.

Generally, the data processors of computer 1542 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the blocks described below in conjunction with a microprocessor or other data processor. The invention also includes the computer itself when programmed according to the methods and techniques described herein.

For purposes of illustration, programs and other executable program components such as the operating system are illustrated herein as discrete blocks, although it is recognized that such programs and components reside at various times in different storage components of the computer, and are executed by the data processor(s) of the computer.

### CONCLUSION

The above-described system includes a media platform that, with its related methods, enable each of multiple media providers to tailor a media player to allow access, enable use, and control use of its media. Because a media provider can tailor this media player to how it wants the media player to behave, the media providers is less likely to need to create a media player of its own. Similarly, users can rely on the media platform rather than multiple media players, saving the users the time and effort they might have to spend learning to use many different media players. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A computer-readable medium comprising computer-executable instructions that perform the following when executed by a computer:
receiving a request to perform a media operation with respect to a media file;
determining a media provider to which the media file is attributable;
assessing if the media provider allows the media operation to be performed with respect to the media file; and
performing the requested media operation if allowed by the media provider.

2. The computer-readable medium of claim 1, wherein the determining is performed with the aid of a unique identifier for the media provider that is within the media file.

3. The computer-readable medium of claim 1, wherein the determining is performed by finding a unique identifier associated with the media provider that is within a header of the media file.

4. The computer-readable medium of claim 1, wherein the determining is performed without communication across a communications network.

5. The computer-readable medium of claim 1, wherein the assessing is performed by executing computer code received from the media provider.

6. The computer-readable medium of claim 1, wherein the assessing is performed by executing a code module received from the media provider and associated with the requested media operation.

7. The computer-readable medium of claim 1, wherein the assessing is performed by calling an API associated with a code module, wherein the code module is received from the media provider and associated with the requested media operation.

8. The computer-readable medium of claim 1, wherein the assessing is performed without communication across a communications network.

9. The computer-readable medium of claim 1, further comprising communicating with the media provider if the media operation is not allowed by the media provider.

10. The computer-readable medium of claim 1, further comprising communicating with the media provider if the media operation is not allowed by the media provider and presenting options to a user for gaining allowance from the media provider.

11. The computer-readable medium of claim 1, wherein the receiving is through a user interface and further comprising communicating with the media provider if the media operation is not allowed by the media provider and presenting options to a user through the user interface for gaining allowance from the media provider.

12. The computer-readable medium of claim 1, wherein the media operation includes downloading the media file to a portable media playing device.

13. The computer-readable medium of claim 1, wherein the media operation includes recording the media file onto a permanent medium.

14. The computer-readable medium of claim 1, wherein the media operation includes recording the media file onto a compact disk.

15. The computer-readable medium of claim 1, wherein the media operation includes recording the media file onto a digital video disk.

16. A system comprising:
a media player; and
a media operation integrator in communication with the media player and capable of receiving, from one of multiple remote media providers, instructions to customize the media player,
wherein the media player is capable of following the instructions.

17. The system of claim 16, wherein the media player is configured to follow the instructions after the media player receives a request to provide an operation with respect to a media file that is attributable to the remote media provider that provided the instructions.

18. The system of claim 16, wherein the media player is configured to play or not play a media file attributable to the remote media provider based on the instructions from the remote media provider.

19. The system of claim 16, wherein the media player is configured to record or not record onto a permanent medium a media file attributable to the remote media provider based on the instructions from the remote media provider.

20. The system of claim 16, wherein the media player is configured to download or not download onto a portable device a media file attributable to the remote media provider based on the instructions from the remote media provider.

21. The system of claim 16, further comprising a user interface customizable by the media player, wherein the instructions include altering the user interface.

22. The system of claim 16, further comprising a registry database of remote media providers from which instructions can be received, wherein the media operation integrator is capable of refusing the instructions if the remote media provider is not included in the registry database.

23. The system of claim 16, wherein the instructions include computer code executable at request of the media player.

24. The system of claim 16, further comprising a registry database of remote media providers from which instructions can be received, wherein the registry database is capable of being altered.

25. The system of claim 16, wherein the media player is capable of building a record of a number of times an operation is performed by the media player with respect to a media file.

26. The system of claim 16, wherein the media player is capable of building a record of a number of times an operation is performed by the media player with respect to a media file and the media operation integrator is further capable of communicating the record to the remote media provider to which the media file is attributable.

27. The system of claim 16, wherein the media player is capable of building a record of a number of times the media player plays a media file and communicating the record to the remote media provider to which the media file is attributable.

28. A system comprising:
a media player; and
a code module received from a remote media provider,
wherein the media player is configured to call the code module when it receives a request to perform an operation with respect to a media file attributable to the remote media provider.

29. The system of claim 28, wherein the media player is further configured to call the code module using one or more APIs.

30. The system of claim 28, wherein the code module includes instructions governing how the media player is to display a name for the remote media provider.

31. The system of claim 28, wherein the code module includes instructions governing how the media player is to display a name for the media file.

32. The system of claim 28, wherein the code module includes instructions governing whether or not the media player is to perform the operation.

33. The system of claim 28, wherein the code module includes instructions governing whether or not the media player is to perform the operation, and the operation includes playing the media file.

34. The system of claim 28, wherein the code module includes instructions governing whether or not the media player is to perform the operation, and the operation includes copying the media file onto a permanent medium.

35. The system of claim 28, wherein the code module includes instructions governing whether or not the media player is to perform the operation, and the operation includes copying the media file onto a temporary medium.

36. The system of claim 28, wherein the code module includes instructions governing how the media player is to structure a user interface to show a user that it is performing the operation.

37. The system of claim 28, further comprising:
a second code module received from a second remote media provider, and
wherein the media player is further configured to call the second code module when it receives a second request to perform a second operation with respect to a second media file attributable to the second remote media provider.

38. The system of claim 28, further comprising:
a second code module received from a second remote media provider, and
wherein the media player is further configured to indicate to a user that:
the media file is attributable to the remote media provider; and
one or more second media files received from the second remote media provider are attributable to the second remote media provider.

39. A method comprising:
receiving input into a media player's user interface to gain access to a remote media provider;
enabling the remote media provider to present a set of media operations within the user interface;
enabling selection of one of the media operations through the user interface; and
performing the selected media operation.

40. The method of claim 39, wherein the selected media operation includes downloading a media file, and further comprising integrating the media file into a media library.

41. The method of claim 39, wherein the selected media operation includes downloading a media file, and further comprising saving the media file in a folder based on metadata associated with the media file.

42. The method of claim 39, wherein the selected media operation includes downloading a media file.

43. The method of claim 39, wherein the selected media operation includes downloading a media file and further comprising:
receiving metadata with respect to the media file; and
renaming the media file based on the metadata.

44. The method of claim 39, wherein the selected media operation includes playing a media file.

45. The method of claim 39, wherein the selected media operation includes recording a media file.

46. The method of claim 39, wherein the enabling the remote media provider includes presenting a media provider user interface within the media player user interface.

47. The method of claim 39, wherein the enabling the remote media provider includes presenting a webpage of the remote media provider within the media player user interface.

48. A computer-readable medium comprising computer-executable instructions that perform the following when executed by a computer:
receiving a media file;
locating metadata associated with the media file; and
storing the media file according to the metadata.

49. The computer-readable medium of claim 48, wherein the storing includes saving the media file in a folder named after an author of the media file.

50. The computer-readable medium of claim 48, wherein the storing includes saving the media file in a folder named after an author of the media file and a subfolder named after an album title of the media file.

51. The computer-readable medium of claim 48, wherein the storing includes saving the media file in a folder named after an author of the media file, a subfolder named after an album title of the media file, and a sub-subfolder named after a track name of the media file.

52. The computer-readable medium of claim 48, wherein the storing includes saving the media file with a name associated with the metadata.

53. The computer-readable medium of claim 48, wherein the storing includes adding a link to the media file in a media library.

54. The computer-readable medium of claim 48, wherein the storing is performed immediately after the receiving and without user interaction.

55. The computer-readable medium of claim 48, wherein if the receiving is interrupted, further comprising automatically restarting the receiving.

56. A user interface comprising:
a first graphical interface configured to enable a user to select a remote media provider from multiple remote media providers;
a second graphical interface configured to enable the user to select a media file presented by the remote media provider; and
a visual space configured to render the media file.

57. The user interface of claim 56, wherein the second graphical interface is tailored to the selected media provider.

58. The user interface of claim 56, wherein the second graphical interface is tailored to the selected media provider and is enclosed within the first graphical interface.

59. The user interface of claim 56, wherein the second graphical interface is generated with a webpage from the selected media provider.

60. A computer-readable medium comprising computer-executable instructions that perform the following when executed by a computer:
receiving a code module from a remote media provider;
receiving a request to perform a media operation; and
executing the code module to determine whether or not the requested media operation is allowable or not allowable.

61. The computer-readable medium of claim 60, wherein the code module is callable with an API.

62. The computer-readable medium of claim 60, further comprising:
receiving a request to integrate the remote media provider into a media player; and
requesting the code module from the remote media provider.

63. The computer-readable medium of claim 60, wherein a media player application receives the code module, receives the request to perform the media operation, and performs the media operation if the requested media operation is allowable.

64. The computer-readable medium of claim 60, further comprising altering a media player application's user interface to include a control enabling a user to select to be connected to the remote media provider.

65. The computer-readable medium of claim 60, further comprising altering a media player application's user interface to include a webpage of the remote media provider.

66. The computer-readable medium of claim 60, further comprising:
altering a media player application's user interface to include a web page of the remote media provider; and
enabling a user to interact with the remote media provider through the media player application's user interface.

67. The computer-readable medium of claim 60, further comprising:
receiving a second code module;
receiving a third code module; and
receiving a fourth code module.

68. The computer-readable medium of claim 60, further comprising:
receiving a second code module; and
performing background processing requested by the remote media provider using the second code module.

69. The computer-readable medium of claim 60, further comprising:
receiving a second code module;
performing background processing requested by the remote media provider; and
communicating a result of the background processing to the remote media provider.

70. The computer-readable medium of claim 60, further comprising:
receiving a second code module; and
compiling a number of times media files attributable to the remote media provider have been played.

71. The computer-readable medium of claim 60, further comprising:
receiving a second code module; and
determining a license status with respect to a media file using the second code module; and
communicating the status to the remote media provider.

72. The computer-readable medium of claim 60, further comprising:
receiving a second code module; and
creating a user interface with aid of executing the second code module.

73. The computer-readable medium of claim 60, wherein the requested operation is playing a media file.

74. The computer-readable medium of claim 60, wherein the requested operation is recording a media file onto a portable media-playing device.

75. The computer-readable medium of claim 60, wherein the requested operation is recording a media file onto a portable media-playing device.

76. The computer-readable medium of claim 60, wherein the requested operation is recording a media file onto a permanent medium.

77. A method comprising:
receiving first instructions from a first remote media provider;
receiving second instructions from a second remote media provider; and
tailoring a media player to conform to the first instructions and the second instructions.

78. The method of claim 77, wherein the tailoring includes altering a user interface of the media player.

79. The method of claim 77, wherein the tailoring includes altering a visual space dedicated to the media player by incorporating a media-control module within the media player that generates a user interface within the visual space.

80. The method of claim 77, wherein the tailoring includes adding a name for the first remote media provider to a media provider selection screen of a user interface of the media player.

81. The method of claim 77, wherein the tailoring includes adding a name for the second remote media provider to a media provider selection screen of a user interface of the media player.

82. The method of claim 77, wherein the tailoring includes adding a selection control enabling a user to select to be connected to a URL associated with the first remote media provider.

83. The method of claim 77, wherein the tailoring includes incorporating a webpage associated with the first remote media provider into a user interface of the media player.

84. The method of claim 77, further comprising receiving a media file from the first remote media provider, wherein the tailoring includes automatically incorporating a link to the media file into a media file library of the media player.

85. A method comprising:
receiving permission from a remote media provider to play a media file;
enabling play of the media file;
determining that the permission is expired;
communicating with the remote media provider to determine if the permission is renewed; and
disabling play of the media file if the permission is not renewed.

86. The method of claim 85, wherein the disabling is not performed until the communicating is performed.

87. The method of claim 85, wherein the determining that the permission is expired is performed in part by recording a number of times that the media file plays.

88. The method of claim 85, wherein the determining that the permission is expired is performed by assessing if a date is passed.

89. The method of claim 85, further comprising playing the media file.

90. The method of claim 85, further comprising:
playing the media file; and
recording that the media file is played.

91. The method of claim 85, further comprising:
playing the media file;
recording that the media file is played; and
communicating the record to the remote media provider.

92. A computer-readable medium comprising computer-executable instructions that perform the following when executed by a computer:
receiving, from a media provider across a communications network, permission allowing a use of a media file;
recording the permitted use; and
performing the permitted use.

93. The computer-readable medium of claim 92, wherein the permitted use includes playing the media file.

94. The computer-readable medium of claim 92, wherein the permitted use includes recording the media file on a permanent medium.

95. The computer-readable medium of claim 92, wherein the permitted use includes recording the media file on a temporary medium.

96. An apparatus comprising:
means for receiving instructions from a remote media provider;
means for receiving a request to perform a media operation; and
means for determining whether or not the requested media operation is allowable or not allowable based on the instructions.

97. The apparatus of claim 96, further comprising:
means for performing the requested media operation.
